(19) United States
(12) Patent Application Publication
(10) Pub. No.: US 2011/0141472 A1
(43) Pub. Date: Jun. 16, 2011

(54) MONITORING LIGHT COMING FROM DIFFERENT AREAS

(75) Inventors: Eduard Johannes Meijer, Eindhoven (NL); Engel Johannes Knibbe, Heeze (NL); Roger Peter Anna Delnoij, Lommel (BE)

(73) Assignee: KONINKLIJKE PHILIPS ELECTRONICS N.V., EINDHOVEN (NL)

(21) Appl. No.: 13/058,761

(22) PCT Filed: Aug. 6, 2009
(86) PCT No.: PCT/IB09/53435

§ 371 Date: Feb. 11, 2011

(30) Foreign Application Priority Data
Aug. 15, 2008 (EP) 08105049.4

(51) Int. Cl. G01N 21/25

(52) U.S. Cl. 356/416

(57) ABSTRACT

Devices (1) for monitoring light (2) coming from different areas comprise first components (10) for selecting light coming from a particular area, second components (20) for filtering the selected light, third components (30) for sensing the filtered light, and fourth components (40) for in response to an output signal of the third component (30) determining spectra of the sensed light and for calculating color parameters such as color points and/or color rendering indices from the spectra. The first components (10) may comprise light angle selectors and redirectors (11), such as rotational mirrors (110) and rotational apparatuses (112), and light angle restrictors (12), such as high aspect ratio structures with absorbing walls (120) or circular holes (121). The second components (20) may comprise filter arrays (21). The third components (30) may comprise sensor arrays (31). The fourth components (40) may comprise controllers (43) for determining the spectra based on prior knowledge of light sources (6) or by using pseudo inverse matrix techniques. Memories (44) may store device information, color matching functions, reflection curves and standardized data for a color metric calculation.

### FIELD OF THE INVENTION

The invention relates to a device for monitoring light coming from different areas, and also relates to a system comprising a device, and to a method.

Examples of such a device are sensors. Examples of such an area are zones and/or objects.

### BACKGROUND OF THE INVENTION

EP 0 652 690 discloses an automatic control device for lighting, which regulates the lighting of a room by taking a plurality of lighting measurements and by combining together the said measurements in order to control the lighting sources individually. It is possible to take account of pluralities of internal lighting measurements and pluralities of external lighting measurements. The device may take account of predictive measurements of external lighting. The said pluralities are delivered by a measuring unit containing a plurality of photosensitive sensors or photo detectors. The processing is carried out by a fuzzy logic unit and/or a neural network. The behaviors of the user and/or the particular features of the room may be taken into account.

### SUMMARY OF THE INVENTION

It is an object of the invention to provide an improved device for monitoring light coming from different areas that does not require a photosensitive sensor or photo detector per area.

Further objects of the invention are to provide a system comprising a device and to provide a method.

According to a first aspect, a device for monitoring light coming from different areas is provided, the device comprising
a first component for selecting light coming from a particular area,
a second component for filtering the selected light,
a third component for sensing the filtered light, and
a fourth component for in response to an output signal of the third component determining a spectrum of the sensed light and for calculating a color parameter from the spectrum.

The first component selects light coming from a particular area, for example in a time multiplexed way. During a first time interval, first light coming from a first area is selected, and during a second time interval, second light coming from a second area is selected. The first and second time intervals may be neighboring time intervals or another time interval may be situated in between. The second component filters the selected light and the third component senses the filtered light. The fourth component determines a spectrum of the sensed light and calculates a color parameter from the spectrum. As a result, by having introduced the first component, it is no longer necessary to have a third component per area. This is a first improvement. And by having introduced the second and fourth components, an intensity as well as a quality of the light coming from different areas can be monitored. This is a second improvement.

Light coming from a particular area may be light reflected from this particular area and/or may be light emitted by one or more light sources in and/or near this particular area. Therefore, the area can be of any size and may comprise or even coincide with (a part of) a surface of a relatively small or large light source.

According to an embodiment, the device is defined by the color parameter comprising a color point and/or a color rendering index. A color point and a color rendering index allow the quality of the light coming from different areas to be monitored well.

According to an embodiment, the device is defined by the first component comprising a light angle selector and redirector. According to a sub-embodiment, the device is defined by the light angle selector and redirector comprising a rotational mirror for selecting the light through rotation of the mirror. According to another sub-embodiment, the device is defined by the light angle selector and redirector comprising a rotational apparatus for selecting the light through rotation of the device.

According to an embodiment, the device is defined by the first component further comprising a light angle restrictor. According to a sub-embodiment, the device is defined by the light angle restrictor comprising a high aspect ratio structure with absorbing walls or with circular holes.

According to an embodiment, the device is defined by the second component comprising a filter array for filtering different colors of the selected light per part of the filter array. According to a sub-embodiment, the device is defined by the third component comprising a sensor array for sensing the filtered colors per part of the sensor array.

According to an embodiment, the device is defined by the fourth component comprising a controller for determining the spectrum based on prior knowledge of a light source or by using a pseudo inverse matrix technique. According to a sub-embodiment, the device is defined by the fourth component further comprising a memory for storing device information and/or color matching functions and/or reflection curves and/or standardized data used and/or required for a calculation of a color metric. According to another sub-embodiment, the device is defined by the fourth component further comprising an amplifier for amplifying the output signal of the third component and/or a converter for converting analog information in the output signal of the third component into digital information.

According to an embodiment, the device is defined by further comprising

a fifth component for in response to an output signal of the fourth component controlling a light source.

According to a second aspect, a system is provided comprising a device and further comprising a sixth component for controlling the light source and/or further comprising the light source.

According to a third aspect, a method is provided for monitoring light coming from different areas, the method comprising
a first step of selecting light coming from a particular area,
a second step of filtering the selected light,
a third step of sensing the filtered light, and
a fourth step of in response to an output of the third step determining a spectrum of the sensed light and of calculating a color parameter from the spectrum.

An insight might be, that a photosensitive sensor or photo detector can be used for different areas.

A basic idea might be, that light coming from a particular area is to be selected and filtered and sensed, and that a spectrum of the sensed light is to be determined and a color parameter is to be calculated from the spectrum.

A problem to provide an improved device for monitoring light coming from different areas that does not require a photosensitive sensor or photo detector per area is solved.

An advantage might be, that the first component prevents a necessity of having a third component per area, and that the second and fourth components allow an intensity as well as a quality of the light coming from different areas to be monitored.

These and other aspects of the invention are apparent from and will be elucidated with reference to the embodiment(s) described hereinafter.

### BRIEF DESCRIPTION OF THE DRAWINGS

In the drawings:

FIG. 1 shows a system comprising a device,

FIG. 2 shows a first embodiment of a light angle selector and redirector,

FIG. 3 shows embodiments of a light angle restrictor,

FIG. 4 shows a second embodiment of a light angle selector and redirector,

FIG. 5 shows sensitivity curves,

FIG. 6 shows a color space,

FIG. 7 shows color rendering index reflection curves,

FIG. 8 shows a room with a device and light sources and

FIG. 9 shows the room in FIG. 8 divided into zones.

### DETAILED DESCRIPTION OF EMBODIMENTS

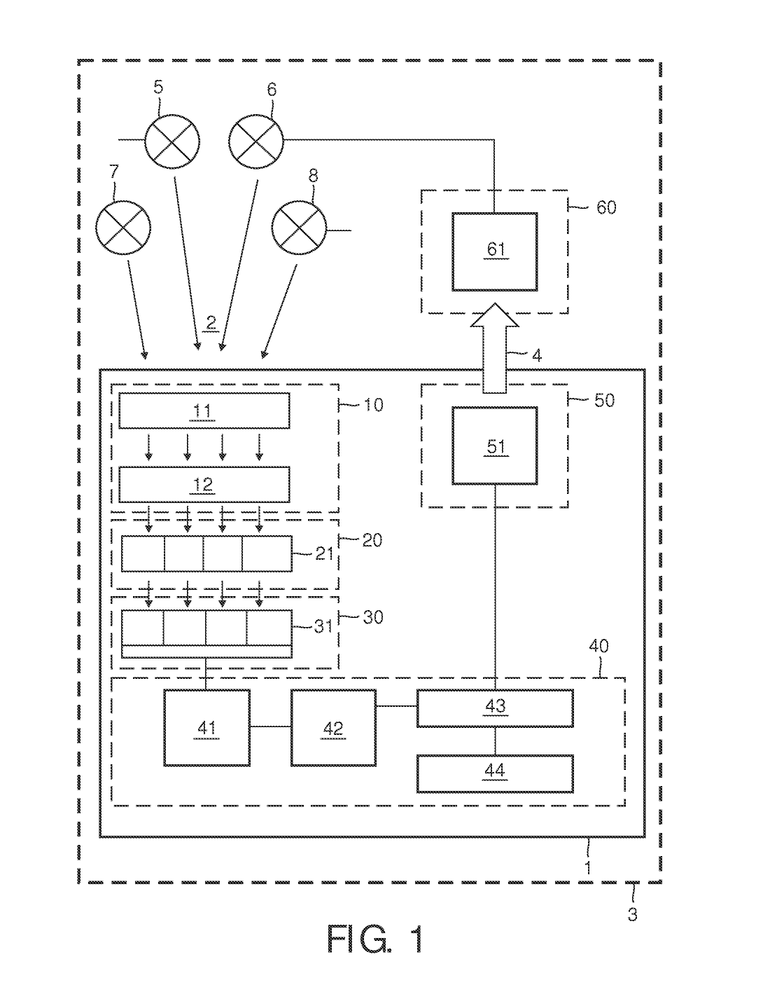

In FIG. 1, a system 3 is shown comprising a device 1 for monitoring light 2 coming from different areas. The device 1 comprises a first component 10 for selecting light coming from a particular area, a second component 20 for filtering the selected light, a third component 30 for sensing the filtered light, and a fourth component 40 for in response to an output signal of the third component 30 determining a spectrum of the sensed light and for calculating a color parameter from the spectrum. Preferably, the color parameter is a color point and/or a color rendering index. The first component 10 comprises for example a light angle selector and redirector 11 and a light angle restrictor 12. The second component 20 comprises for example a filter array 21 for filtering different colors of the selected light per part of the filter array 21. A left part for example filters the color blue, a next part for example filters the color green, a next part for example filters the color yellow, and a right part for example filters the color red. Examples of such a filter array 21 are interference filter arrays (for example mirror—cavity—mirror that can all be dielectric or for example (metal) mirror—(dielectric) cavity—(metal) mirror etc.). The third component 30 for example comprises a sensor array 31 for sensing the filtered colors per part of the sensor array 31. A left part for example senses the color blue, a next part for example senses the color green, a next part for example senses the color yellow, and a right part for example senses the color red. Examples of such a sensor array 31 are silicon photodiodes or CMOS or CCD units.

The fourth component 40 for example comprises an amplifier 41 such as for example an operational amplifier for amplifying the output signal of the third component 30 and for example comprises a converter 42 such as for example a analog-to-digital converter for converting analog information in the output signal of the third component 30 into digital information. The fourth component 40 further for example comprises a controller 43 for determining the spectrum based on prior knowledge of a light source 6 or by using a pseudo inverse matrix technique. The fourth component 40 further for example comprises a memory 44 for storing device information and/or color matching functions and/or reflection curves and/or standardized data used and/or required for a calculation of a color metric. The memory 44 for example holds the calibrated filtered sensor information. In addition, the memory 44 may hold the color matching functions and the standard reflection curves for calculating the color rendering index (see later on). The controller 43 uses the information from the memory and the sensor array 31 to determine an intensity, a color point and a color rendering index of the light source(s) 6 illuminating the sensor array 31 from the angle set by the light angle selector and redirector 11 and the light angle restrictor 12.

The device 1 may further comprise a fifth component 50 for in response to an output signal of the fourth component 40 controlling the light source 6. Such a fifth component 50 may comprise a wired or wireless interface 51 for sending a signal 4 to a wired or wireless interface 61 of a sixth component 60 of the system 3 for controlling the light source 6. The system 3 may further comprise the light source 6. Other light sources 5, 7 and 8 may form part of the system 3 and may be controlled via the same sixth component 60 or via another component not shown. Any outside communication can be done via a wireless node such as Bluetooth, Zigbee, or RF, or through a cable, and can be connected to one or more light source controllers, which can subsequently compare the measured light settings to a required light setting set by a user and can subsequently adjust the light source settings, thereby closing the feedback loop.

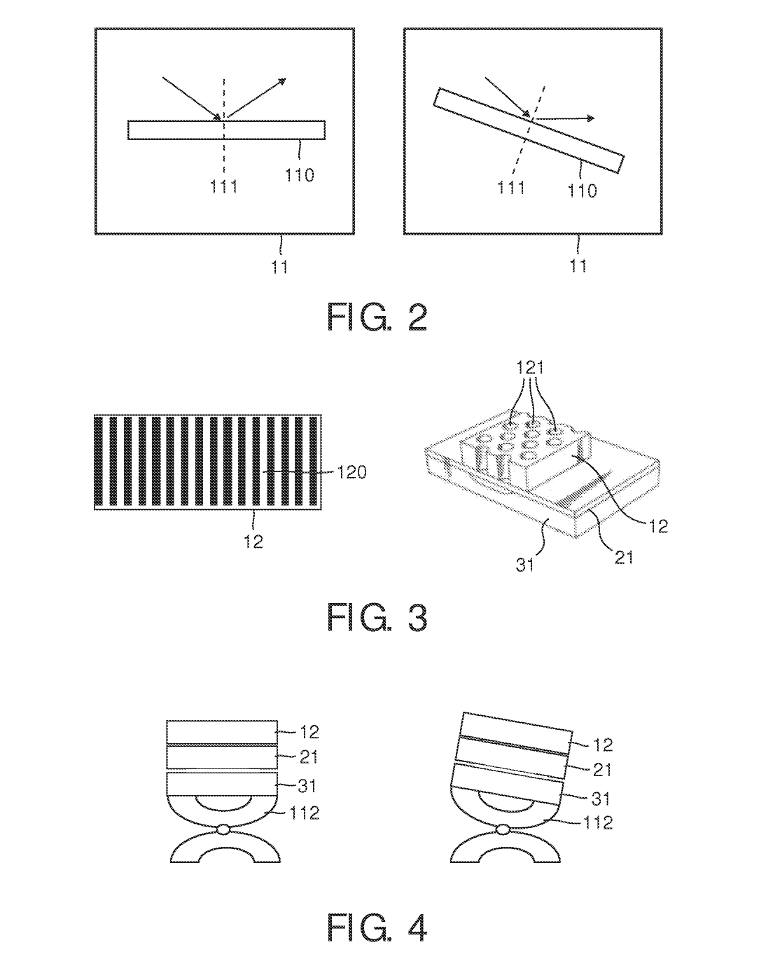

In FIG. 2, a first embodiment of a light angle selector and redirector 11 is shown. The light angle selector and redirector 11 comprises a rotational mirror 110 with an axis 111 for selecting the incoming light through rotation of the mirror 110. In the left and right part of FIG. 2 two different positions of the mirror 110 are shown. As a result, incoming light as indicated by the incoming arrow is reflected differently into outgoing light as indicated by the outgoing arrow.

In FIG. 3, embodiments of a light angle restrictor 12 are shown comprising a high aspect ratio structure with absorbing walls 120 (left) or with circular holes 121 (right). The absorbing walls 120 are restrictive in one direction, the circular holes 121 are restrictive in two directions.

In FIG. 4, a second embodiment of a light angle selector and redirector 11 is shown. The light angle selector and redirector 11 comprises a rotational apparatus 112 for selecting the incoming light through rotation of the device 1.

Generally, the light angle selector and redirector 11 and/or the light angle restrictor 12 may be active or passive and/or tunable or fixed. Active/tunable units may be light directors based on electrowetting cells, liquid crystal cells, mechanical wedges, switchable reflector flakes, mechanical apertures, dual LC cells etc. Passive/fixed units may be holes lasered in black plastic, moulded structures, refractive & reflective structures etc.

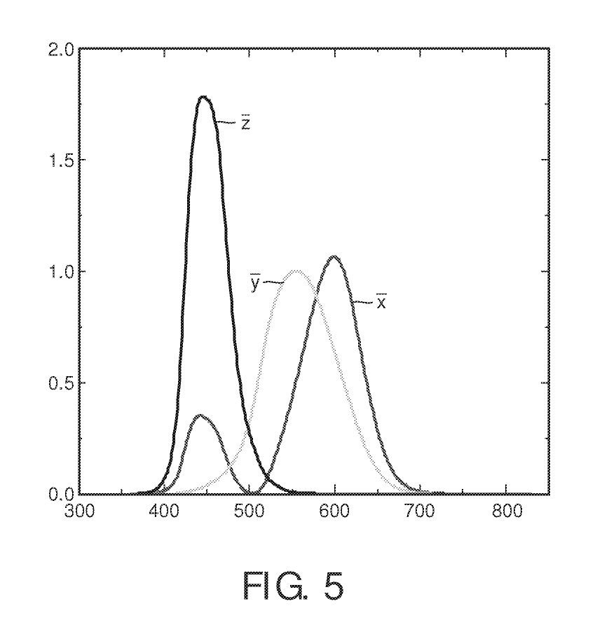

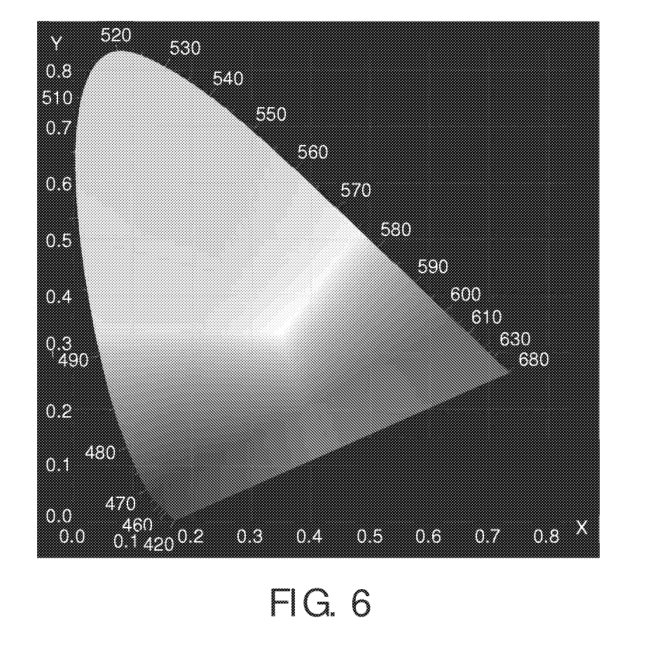

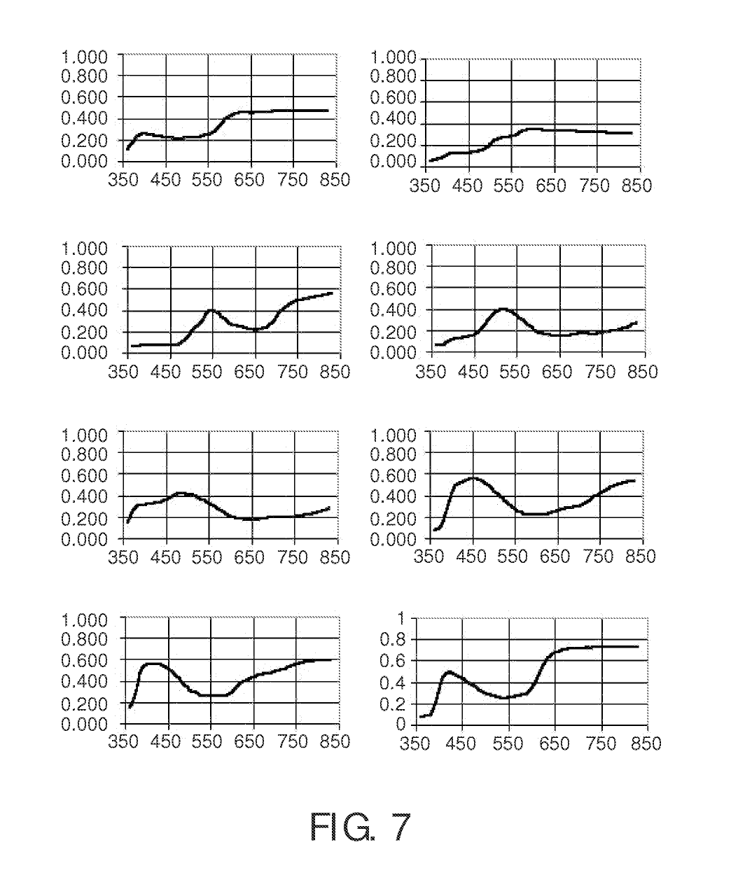

In FIG. 5, sensitivity curves are shown (function value versus wavelength, x=red, y=green, z=blue). In FIG. 6, a color space is shown (CIE 1931 chromaticity diagram). In FIG. 7, color rendering index reflection curves are shown. The Color Rendering Index (CRI) of a light source is a relative measure of an accuracy with which the colors of an object, illuminated by that light source, are rendered in comparison to a standard (i.e. a black body radiator or daylight) reference light source. When the CRI is calculated, it can be rated on a scale from 0-100. On this scale, a CRI of 100 would show that all color samples illuminated by a light source in question, would appear to have the same color as those same samples illuminated by a reference source. A negative CRI can be calculated, but a goal for most lighting systems that produce white light is to have a positive CRI. The calculation of the CRI is done against 24 reference color charts or a reduced number is calculated against 8 of these color charts. The reflectance curves of these 8 charts is given in FIG. 7.

The controller 43 uses the calibrated filter data from the memory 44 and the information from the sensor array 31 to determine a spectrum. This can be done in several ways; (A) when prior knowledge of the source is available and a general description of the spectral emission is known and (B) by using a pseudo inverse matrix technique wherein a pseudo inverse matrix is generated from the calibrated filter data and this matrix is multiplied with the measured information from the sensor array 31 to obtain an estimate of the spectrum. From the spectrum, the color point and the color rendering index can be calculated directly.

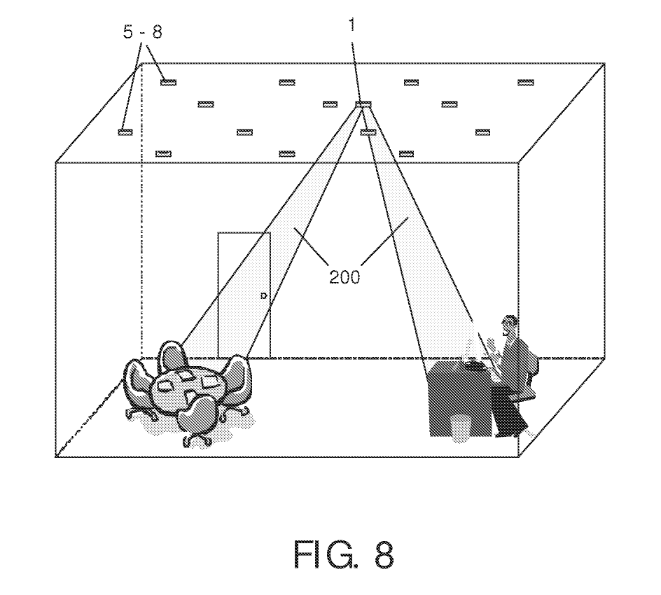

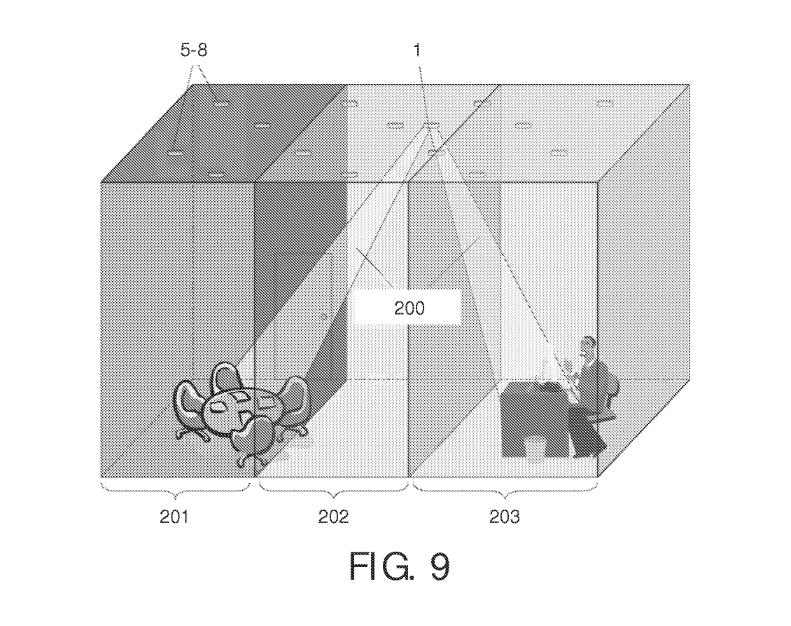

In FIG. 8, a room is shown comprising light sources 5-8 and comprising a device 1 with different light monitoring angles 200 for two different working areas. In all lighting spaces there are areas in which the quality of the light needs to be controlled and monitored to a high degree. Examples are the various working areas in an office environment. The device 1 may for example be located in the ceiling to monitor the different areas in terms of light intensity, color point and color rendering index by looking specifically at these areas through light angle selecting structures. The device 1 can communicate any measured results with the lighting controls architecture which can adjust the settings of the light sources 5-8 if needed. Also, objects mounted on/against the wall can be monitored by the device 1 for correct illumination. Alternatively, one can choose to divide the room into different zones. The light intensity and light color properties of each zone are then monitored. In FIG. 9, the room is shown again now divided into three light measurement zones 201-203.

Summarizing, devices 1 for monitoring light 2 coming from different areas comprise first components 10 for selecting light coming from a particular area, second components 20 for filtering the selected light, third components 30 for sensing the filtered light, and fourth components 40 for in response to an output signal of the third component 30 determining spectra of the sensed light and for calculating color parameters such as color points and/or color rendering indices from the spectra. The first components 10 may comprise light angle selectors and redirectors 11, such as rotational mirrors 110 and rotational apparatuses 112, and light angle restrictors 12, such as high aspect ratio structures with absorbing walls 120 or circular holes 121. The second components 20 may comprise filter arrays 21. The third components 30 may comprise sensor arrays 31. The fourth components 40 may comprise controllers 43 for determining the spectra based on prior knowledge of light sources 5-8 or by using pseudo inverse matrix techniques. Memories 44 may store device information, color matching functions, reflection curves and standardized data for a color metric calculation.

While the invention has been illustrated and described in detail in the drawings and foregoing description, such an illustration and description are to be considered illustrative or exemplary and not restrictive; the invention is not limited to the disclosed embodiments. For example, it is possible to operate the invention in an embodiment wherein different parts of the different disclosed embodiments are combined into a new embodiment.

Other variations to the disclosed embodiments can be understood and effected by those skilled in the art in practicing the claimed invention from a study of the drawings, the disclosure and the appended claims. In the claims, the word “comprising” does not exclude other elements or steps and the indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference symbols in the claims should not be construed as limiting the scope.

1. A device for monitoring light coming from different areas, the device comprising
a first component for selecting light coming from a particular area,
a second component for filtering the selected light,
a third component for sensing the filtered light, and
a fourth component for in response to an output signal of the third component determining a spectrum of the sensed light and for calculating a color parameter from the spectrum, the first component comprising a light angle selector and a redirector.

2. The device as claimed in claim 1, the color parameter comprising a color point and/or a color rendering index.

3. The device as claimed in claim 1, the first component being arranges to select the light coming from the particular area in a time multiplexed way, whereby, during a first time interval, first light coming from a first area is selected, and, durance a second time interval, second light coming from a second area is selected.

4. The device as claimed in claim 1, the light angle selector and redirector comprising a rotational mirror for selecting the light through rotation of the mirror.

5. The device as claimed in claim 1, the light angle selector and redirector comprising a rotational apparatus for selecting the light through rotation of the device.

6. The device as claimed in claim 1, the first component further comprising a light angle restrictor.

7. The device as claimed in claim 6, the light angle restrictor comprising a high aspect ratio structure with absorbing walls or with circular holes.

8. The device as claimed in claim 1, the second component comprising a filter array for filtering different colors of the selected light per part of the filter array.

9. The device as claimed in claim 8, the third component comprising a sensor array for sensing the filtered colors per part of the sensor array.

10. The device as claimed in claim 1, the fourth component comprising a controller for determining the spectrum based on prior knowledge of a light source or by using a pseudo inverse matrix technique.

11. The device as claimed in claim 10, the fourth component further comprising a memory for storing device information and/or color matching functions and/or reflection curves and/or standardized data used and/or required for a calculation of a color metric.

12. The device as claimed in claim 10, the fourth component further comprising an amplifier for amplifying the output signal of the third component and/or a converter for converting analog information in the output signal of the third component into digital information.

13-14. (canceled)

15. A method for monitoring light coming from different areas, the method comprising
selecting light coming from a particular area,
filtering the selected light,
sensing the filtered light, and
in response to an output of the sensing step, determining a spectrum of the sensed light and calculating a color parameter from the spectrum.
